(19) United States
(12) Patent Application Publication
(10) Pub. No.: US 2026/0208751 A1
(43) Pub. Date: Jul. 23, 2026

(54) VEHICLE CONTROL DEVICE, VEHICLE, AND VEHICLE CONTROL METHOD

(71) Applicant: TOYOTA JIDOSHA KABUSHIKI KAISHA, Toyota-shi (JP)

(72) Inventor: Kyosuke TOGASHI, Tokyo (JP)

(73) Assignee: TOYOTA JIDOSHA KABUSHIKI KAISHA, Toyota-shi (JP)

(21) Appl. No.: 19/413,387

(22) Filed: Dec. 9, 2025

(30) Foreign Application Priority Data
Jan. 21, 2025 (JP) 2025-008419

(51) Int. Cl. B60W 50/00; B60W 50/08

(52) U.S. Cl. CPC B60W 50/0098; B60W 50/082; B60W 2050/0083; B60W 2420/403; B60W 2420/54; B60W 2520/16; B60W 2555/20

(57) ABSTRACT

A vehicle control device includes: a communication unit configured to receive external situation information that is obtained using one or more in-vehicle sensors and that indicates an external situation of a vehicle; and a control unit configured to automatically adjust an internal environment of the vehicle based on the external situation information received by the communication unit, after a rest mode is set by a user that rides in the vehicle and before the rest mode is terminated, the rest mode being a mode relevant to the internal environment.

### CROSS-REFERENCE TO RELATED APPLICATION

This application claims priority to Japanese Patent Application No. 2025-008419 filed on January 21, 2025. The disclosure of the above-identified application, including the specification, drawings, and claims, is incorporated by reference herein in its entirety.

### BACKGROUND

### Technical Field

The present disclosure relates to a vehicle control device, a vehicle, and a vehicle control method.

### Description of Related Art

Japanese Unexamined Patent Application Publication No. 2023-070099 (JP 2023-070099 A) discloses a vehicle control device that changes the reclining state of a driver's seat based on whether an autonomous driving level is lower than a nap-enabled autonomous driving level.

### SUMMARY

In the related art, it is not possible to automatically set and maintain an optimal environment for the sleep of an occupant, in consideration of the external situation of a vehicle. Therefore, the quality of the sleep of the occupant is constrained.

The present disclosure provides a vehicle control device, a vehicle, and a vehicle control method that improve the quality of the rest of the occupant. The rest includes sleep and simply relaxing.

A vehicle control device according to a first aspect of the present disclosure includes: a communication unit configured to receive external situation information that is obtained using one or more in-vehicle sensors and that indicates an external situation of a vehicle; and a control unit configured to automatically adjust an internal environment of the vehicle based on the external situation information received by the communication unit, after a rest mode is set by a user that rides in the vehicle and before the rest mode is terminated, the rest mode being a mode relevant to the internal environment.

In the vehicle control device according to the first aspect of the present disclosure, the control unit may be configured to accept the setting of the rest mode only when the vehicle is at a standstill.

In the vehicle control device according to the first aspect of the present disclosure, the control unit may be configured to acquire the external situation information through the communication unit in real time and automatically alter the internal environment depending on change in the external situation, after the rest mode is set and before the rest mode is terminated.

In the vehicle control device according to the first aspect of the present disclosure, the one or more in-vehicle sensors may include an inclination sensor. The external situation information may include information that is obtained using the inclination sensor and that indicates an inclination of the vehicle with respect to a gravity direction. The control unit may be configured to automatically adjust one or both of angles of a backrest and a footrest of a seat in which the user sits, depending on the inclination, after the rest mode is set and before the rest mode is terminated.

In the vehicle control device according to the first aspect of the present disclosure, the control unit may be configured to automatically adjust one or both of the angles of the backrest and the footrest, to such an angle that one or both of the backrest and the footrest are orthogonal to the gravity direction, after the rest mode is set and before the rest mode is terminated.

In the vehicle control device according to the first aspect of the present disclosure, the one or more in-vehicle sensors may include a temperature sensor. The external situation information may include information that is obtained using the temperature sensor and that indicates an external temperature of the vehicle. The control unit may be configured to automatically alter setting of an in-vehicle heater or an in-vehicle air-conditioner depending on change in the external temperature, after the rest mode is set and before the rest mode is terminated.

In the vehicle control device according to the first aspect of the present disclosure, the communication unit may be configured to further receive internal environment information that is obtained using a separate temperature sensor and that indicates an internal temperature of the vehicle, the separate temperature sensor being an in-vehicle sensor that is separate from the one or more in-vehicle sensors. The control unit may be configured to acquire the internal environment information through the communication unit in real time and automatically alter the setting of the in-vehicle heater or the in-vehicle air-conditioner depending on change in the internal temperature, when the control unit detects that the external temperature is out of a desired range, after the rest mode is set and before the rest mode is terminated.

In the vehicle control device according to the first aspect of the present disclosure, the one or more in-vehicle sensors may include a temperature sensor. The external situation information may include information that is obtained using the temperature sensor and that indicates an external temperature of the vehicle. The control unit may be configured to automatically open or close a window of the vehicle depending on change in the external temperature, after the rest mode is set and before the rest mode is terminated.

In the vehicle control device according to the first aspect of the present disclosure, the one or more in-vehicle sensors may further include an odor sensor or an air quality sensor. The external situation information may further include information that is obtained using the odor sensor and that indicates an external odor of the vehicle, or information that is obtained using the air quality sensor and that indicates an external air pollution degree of the vehicle. The control unit may be configured to close the window regardless of the change in the external temperature, when the control unit detects that the external odor or the external air pollution degree is out of a desired range.

In the vehicle control device according to the first aspect of the present disclosure, the one or more in-vehicle sensors may include a humidity sensor. The external situation information may include information that is obtained using the humidity sensor and that indicates an external humidity of the vehicle. The control unit may be configured to automatically alter setting of an in-vehicle air-conditioner or an in-vehicle humidifier depending on change in the external humidity, after the rest mode is set and before the rest mode is terminated.

In the vehicle control device according to the first aspect of the present disclosure, the communication unit may be configured to further receive internal environment information that is obtained using a carbon dioxide sensor and that indicates an internal carbon dioxide concentration of the vehicle, the carbon dioxide sensor being an in-vehicle sensor that is separate from the one or more in-vehicle sensors. The control unit may be configured to acquire the internal environment information through the communication unit in real time and automatically open or close a window of the vehicle depending on change in the internal carbon dioxide concentration, after the rest mode is set and before the rest mode is terminated.

In the vehicle control device according to the first aspect of the present disclosure, the one or more in-vehicle sensors may include an odor sensor or an air quality sensor. The external situation information may include information that is obtained using the odor sensor and that indicates an external odor of the vehicle, or information that is obtained using the air quality sensor and that indicates an external air pollution degree of the vehicle. The control unit may be configured to close the window regardless of the change in the internal carbon dioxide concentration, when the control unit detects that the external odor or the external air pollution degree is out of a desired range.

In the vehicle control device according to the first aspect of the present disclosure, the communication unit may be configured to further receive internal environment information that is obtained using a carbon dioxide sensor and that indicates an internal carbon dioxide concentration of the vehicle, the carbon dioxide sensor being an in-vehicle sensor that is separate from the one or more in-vehicle sensors. The control unit may be configured to acquire the internal environment information through the communication unit in real time and automatically switch an in-vehicle air-conditioner between internal air circulation and external air introduction depending on change in the internal carbon dioxide concentration, after the rest mode is set and before the rest mode is terminated.

In the vehicle control device according to the first aspect of the present disclosure, the one or more in-vehicle sensors may include an odor sensor or an air quality sensor. The external situation information may include information that is obtained using the odor sensor and that indicates an external odor of the vehicle, or information that is obtained using the air quality sensor and that indicates an external air pollution degree of the vehicle. The control unit may be configured to set the in-vehicle air-conditioner to the internal air circulation regardless of the change in the internal carbon dioxide concentration, when the control unit detects that the external odor or the external air pollution degree is out of a desired range.

In the vehicle control device according to the first aspect of the present disclosure, the one or more in-vehicle sensors may include an acoustic sensor. The external situation information may include information that is obtained using the acoustic sensor and that indicates an external noise of the vehicle. The control unit may be configured to automatically alter vehicle acoustics depending on change in the external noise, after the rest mode is set and before the rest mode is terminated.

In the vehicle control device according to the first aspect of the present disclosure, the one or more in-vehicle sensors may include an illuminance sensor. The external situation information may include information that is obtained using the illuminance sensor and that indicates an external illuminance of the vehicle. The control unit may be configured to automatically open or close a shade attached to a window of the vehicle depending on change in the external illuminance, after the rest mode is set and before the rest mode is terminated.

In the vehicle control device according to the first aspect of the present disclosure, the one or more in-vehicle sensors include an illuminance sensor. The external situation information may include information that is obtained using the illuminance sensor and that indicates an external illuminance of the vehicle. The control unit may be configured to automatically alter a vehicle illumination depending on change in the external illuminance, after the rest mode is set and before the rest mode is terminated.

In the vehicle control device according to the first aspect of the present disclosure, the one or more in-vehicle sensors include an odor sensor. The external situation information may include information that is obtained using the odor sensor and that indicates an external odor of the vehicle. The control unit may be configured to automatically alter setting of an in-vehicle aroma machine depending on change in the external odor, after the rest mode is set and before the rest mode is terminated.

A vehicle according to a second aspect of the present disclosure includes: the vehicle control device according to the first aspect; and the one or more in-vehicle sensors.

A vehicle control method according to a third aspect of the present disclosure includes: receiving external situation information that is obtained using one or more in-vehicle sensors and that indicates an external situation of a vehicle; and automatically adjusting an internal environment of the vehicle based on the received external situation information, after a rest mode is set by a user that rides in the vehicle and before the rest mode is terminated, the rest mode being a mode relevant to the internal environment.

With the present disclosure, the quality of the rest of the occupant is improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing an example of a vehicle according to an embodiment of the present disclosure;

FIG. 2 is a block diagram showing a configuration of a vehicle control device according to the embodiment of the present disclosure, connection with in-vehicle interfaces, and connection with in-vehicle sensors;

FIG. 3 is a flowchart showing a first example of an operation of the vehicle control device according to the embodiment of the present disclosure;

FIG. 4 is a flowchart showing a second example of the operation of the vehicle control device according to the embodiment of the present disclosure;

FIG. 5 is a flowchart showing a third example of the operation of the vehicle control device according to the embodiment of the present disclosure;

FIG. 6 is a flowchart showing a fourth example of the operation of the vehicle control device according to the embodiment of the present disclosure; and

FIG. 7 is a flowchart showing a fifth example of the operation of the vehicle control device according to the embodiment of the present disclosure.

### DETAILED DESCRIPTION OF EMBODIMENTS

An embodiment of the present disclosure will be described below with reference to the drawings.

In each drawing, the same or equivalent parts are denoted by the same reference characters. In the description of the present embodiment, the description of the same or equivalent parts is omitted or simplified, as appropriate.

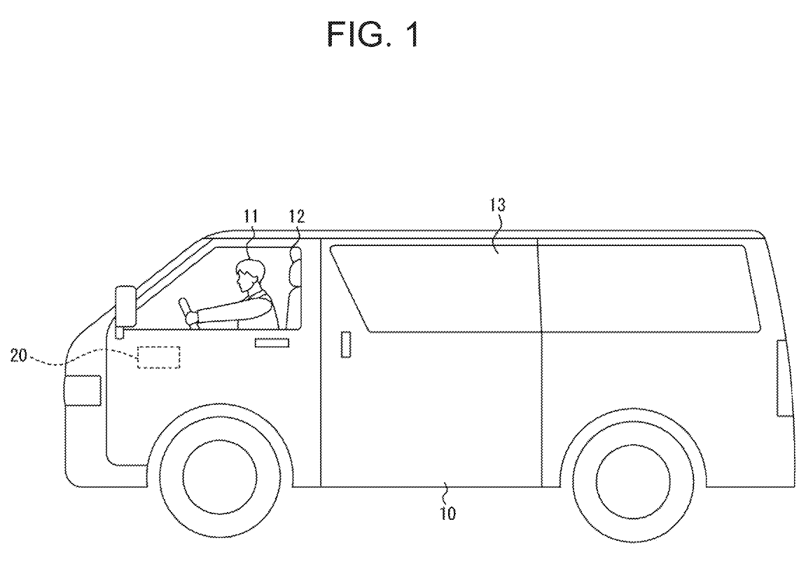

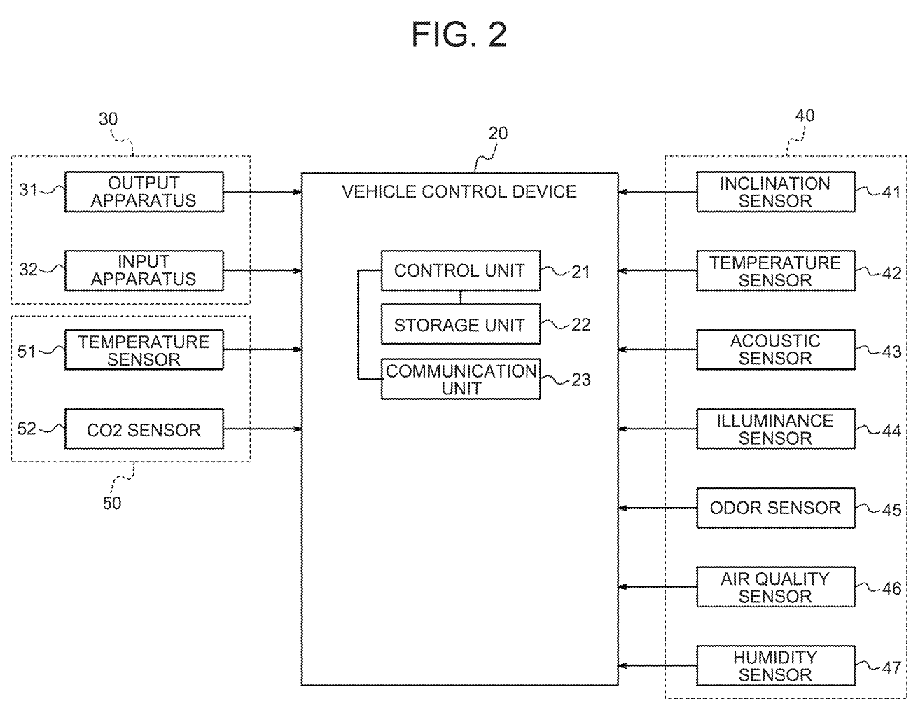

A configuration of a vehicle 10 according to the embodiment will be described with reference to FIG. 1 and FIG. 2.

The vehicle 10 includes a vehicle control device 20, one or more in-vehicle interfaces 30, one or more in-vehicle sensors 40, and one or more separate in-vehicle sensors 50. The vehicle control device 20 can communicate with the in-vehicle interfaces 30 and the in-vehicle sensors 40, 50 through an in-vehicle network such as a CAN. "CAN" is an abbreviation for controller area network.

For example, the vehicle 10 is an arbitrary kind of automobile such as a gasoline vehicle, a diesel vehicle, a hydrogen vehicle, an HEV, a PHEV, a BEV, or a FCEV. "HEV" is an abbreviation for hybrid electric vehicle. "PHEV" is an abbreviation for plug-in hybrid electric vehicle. "BEV" is an abbreviation for battery electric vehicle. "FCEV" is an abbreviation for fuel cell electric vehicle. In the embodiment, the vehicle 10 is driven by a user 11, but the driving may be automated at an arbitrary level. For example, the level of the automation is one of Level 1 to Level 5 in the levels definition by SAE. "SAE" is an abbreviation for Society of Automotive Engineers. The vehicle 10 may be a MaaS-dedicated vehicle. "MaaS" is an abbreviation for Mobility as a Service.

The vehicle control device 20 is an in-vehicle computer. As a modification, instead of being installed in the vehicle 10, the vehicle control device 20 may be installed at a place distant from the vehicle 10, as long as the vehicle control device 20 can communicate with the in-vehicle interfaces 30 and the in-vehicle sensors 40, 50 through a network such as a mobile communication network or the internet. In such a modification, the vehicle control device 20 may be a general-purpose computer such as a PC, may be a server computer such as a cloud server, or may be a dedicated computer. "PC" is an abbreviation for personal computer.

In the embodiment, the in-vehicle interfaces 30 include an output apparatus 31 and an input apparatus 32, and may include apparatuses other than these. The in-vehicle interfaces 30 are used for interchange and information exchange with the user 11 when the user 11 rides in the vehicle 10.

For example, the output apparatus 31 is a display or a speaker. For example, the display is an LCD or an organic EL display. "LCD" is an abbreviation for liquid crystal display. "EL" is an abbreviation for electroluminescent. The display may be a display audio. The output apparatus 31 outputs information that is obtained by an operation of the vehicle control device 20.

For example, the input apparatus 32 is a physical key, an electrostatic capacitance key, a pointing device, a touch screen provided integrally with a display, a camera, or a microphone. The input apparatus 32 accepts an input of information that is used for the operation of the vehicle control device 20.

In the embodiment, the in-vehicle sensors 40 include an inclination sensor 41, a temperature sensor 42, an acoustic sensor 43, an illuminance sensor 44, an odor sensor 45, an air quality sensor 46, and a humidity sensor 47, but may include only some of these, or may include sensors other than these. The in-vehicle sensors 40 are used for obtaining external situation information. The external situation information is information that indicates an external situation of the vehicle 10.

For example, the inclination sensor 41 is a G sensor or an acceleration meter. The inclination sensor 41 measures an inclination of the vehicle 10 with respect to a gravity direction.

For example, the temperature sensor 42 is a thermometer. The temperature sensor 42 measures an external temperature of the vehicle 10.

For example, the acoustic sensor 43 is a microphone or a noise level meter. The acoustic sensor 43 measures an external noise of the vehicle 10.

For example, the illuminance sensor 44 is a photometer or an illuminometer. The illuminance sensor 44 measures an external illuminance of the vehicle 10.

For example, the odor sensor 45 is an odor meter. The odor sensor 45 measures an external odor of the vehicle 10.

For example, the air quality sensor 46 is an atmosphere pollution sensor or an air quality monitor. The air quality sensor 46 measures an external air pollution degree of the vehicle 10.

For example, the humidity sensor 47 is a hygrometer. The humidity sensor 47 measures an external humidity of the vehicle 10.

In the embodiment, the in-vehicle sensors 50 include a temperature sensor 51 and a carbon dioxide sensor 52, but may include one of these, or may include sensors other than these. The in-vehicle sensors 50 are used for obtaining internal environment information. The internal environment information is information that indicates an internal environment of the vehicle 10.

For example, the temperature sensor 51 is a thermometer. The temperature sensor 51 measures an internal temperature of the vehicle 10.

For example, the carbon dioxide sensor 52 is an optical-type, electrochemical-type, or semiconductor-type carbon dioxide sensor. The carbon dioxide sensor 52 measures an internal carbon dioxide concentration of the vehicle 10.

An overview of the embodiment will be described with reference to FIG. 1 and FIG. 2.

The vehicle control device 20 receives the external situation information. The vehicle control device 20 automatically adjusts the internal environment of the vehicle 10 based on the received external situation information, after a rest mode is set by the user 11 that rides in the vehicle 10 and before the rest mode is terminated. For example, the vehicle control device 20 automatically adjusts the internal environment of the vehicle 10 by controlling an actuator that actuates a seat 12 of the vehicle 10 in which the user 11 sits, a window 13 of the vehicle 10, or other equipment of the vehicle 10.

The rest mode is a mode relevant to the internal environment of the vehicle 10. In the embodiment, the rest mode is a "Dream mode" that makes an environment in which sleep is easy, but may be a mode that makes an environment in which mere relaxing is easy. Another mode relevant to the internal environment of the vehicle 10, as exemplified by a mode that makes an environment in which concentration on driving is easy, may be capable of being set by switching with the rest mode.

In the embodiment, it is possible to automatically set and maintain an optimal environment for the rest of an occupant, in consideration of the external situation of the vehicle 10. Therefore, the quality of the rest of the occupant is improved.

The vehicle control device 20 may acquire the external situation information in real time, after the rest mode is set and before the rest mode is terminated. The vehicle control device 20 may automatically alter the internal environment of the vehicle 10, depending on the change in the external situation of the vehicle 10. That is, the vehicle control device 20 may dynamically adjust the internal environment of the vehicle 10, depending on the real-time external situation of the vehicle 10.

A configuration of the vehicle control device 20 according to the embodiment will be described with reference to FIG. 2.

The vehicle control device 20 includes a control unit 21, a storage unit 22, and a communication unit 23.

The control unit 21 includes at least one processor, at least one programmable circuit, at least one dedicated circuit, or an arbitrary combination of these. The processor is a general-purpose processor such as a CPU or a GPU, or a dedicated processor for a particular process. "CPU" is an abbreviation for central processing unit. "GPU" is an abbreviation for graphics processing unit. For example, the programmable circuit is an FPGA. "FPGA" is an abbreviation for field-programmable gate array. For example, the dedicated circuit is an ASIC. "ASIC" is an abbreviation for application specific integrated circuit. The control unit 21 executes processes related to the operation of the vehicle control device 20 while controlling parts of the vehicle control device 20.

The storage unit 22 includes at least one semiconductor memory, at least one magnetic memory, at least one optical memory, or an arbitrary combination of these. For example, the semiconductor memory is a RAM, a ROM, or a flash memory. "RAM" is an abbreviation for random access memory. "ROM" is an abbreviation for read only memory. For example, the RAM is an SRAM or a DRAM. "SRAM" is an abbreviation for static random access memory. "DRAM" is an abbreviation for dynamic random access memory. For example, the ROM is an EEPROM. "EEPROM" is an abbreviation for electrically erasable programmable read only memory. For example, the flash memory is an SSD. "SSD" is an abbreviation for solid-state drive. For example, the magnetic memory is an HDD. "HDD" is an abbreviation for hard disk drive. For example, the storage unit 22 functions as a main storage device, an auxiliary storage device, or a cache memory. In the storage unit 22, information that is used for the operation of the vehicle control device 20 and information that is obtained by the operation of the vehicle control device 20 are stored.

The communication unit 23 includes at least one communication module. For example, the communication module is a module that complies with a mobile communication standard such as LTE, 4G standard, or 5G standard, or a wireless LAN communication standard such as IEEE802.11. "LTE" is an abbreviation for Long Term Evolution. "4G" is an abbreviation for 4th generation. "5G" is an abbreviation for 5th generation. "IEEE" is an abbreviation for Institute of Electrical and Electronics Engineers. "LAN" is an abbreviation for local area network. The communication unit 23 communicates with the in-vehicle interfaces 30 and the in-vehicle sensors 40, 50. The communication unit 23 receives information that is used for the operation of the vehicle control device 20, and sends information that is obtained by the operation of the vehicle control device 20.

Functions of the vehicle control device 20 are realized when a processor as the control unit 21 executes a program according to the embodiment. That is, the functions of the vehicle control device 20 are realized by software. The program causes a computer to function as the vehicle control device 20 by causing the computer to execute the operation of the vehicle control device 20. That is, the computer functions as the vehicle control device 20 by executing the operation of the vehicle control device 20 in accordance with the program.

The program can be stored in a non-transitory computer-readable medium. For example, the non-transitory computer-readable medium is a flash memory, a magnetic recording device, an optical disc, a magneto-optical recording medium, or a ROM. For example, the distribution of the program is performed by the sale, assignment, or rental of a portable medium in which the program is stored, as exemplified by an SD card, a DVD, or a CD-ROM. "SD" is an abbreviation for Secure Digital. "DVD" is an abbreviation for digital versatile disc. "CD-ROM" is an abbreviation for compact disc read only memory. The program may be distributed by storing the program in a storage of a server and transferring the program from the server to another computer. The program may be provided as a program product.

For example, the computer temporarily stores the program stored in a portable medium or the program transferred from the server, in a main storage device. Then, the computer reads the program stored in the main storage device, by the processor, and the processor executes a process in accordance with the read program. The computer may directly read the program from the portable medium, and may execute the process in accordance with the program. Each time a program is transferred from the server to the computer, the computer may successively execute a process in accordance with the received program. The process may be executed by a so-called ASP-type service that realizes functions by only giving an instruction of execution and acquiring a result without transferring the program from the server to the computer. "ASP" is an abbreviation for application service provider. The program includes information that is used for processing by an electronic computer and that is equivalent to the program. For example, data that is not a direct command for a computer but has a property that defines processing of the computer corresponds to the "information equivalent to the program".

Some or all of the functions of the vehicle control device 20 may be realized by a programmable circuit or a dedicated circuit as the control unit 21. That is, some or all of the functions of the vehicle control device 20 may be realized by hardware.

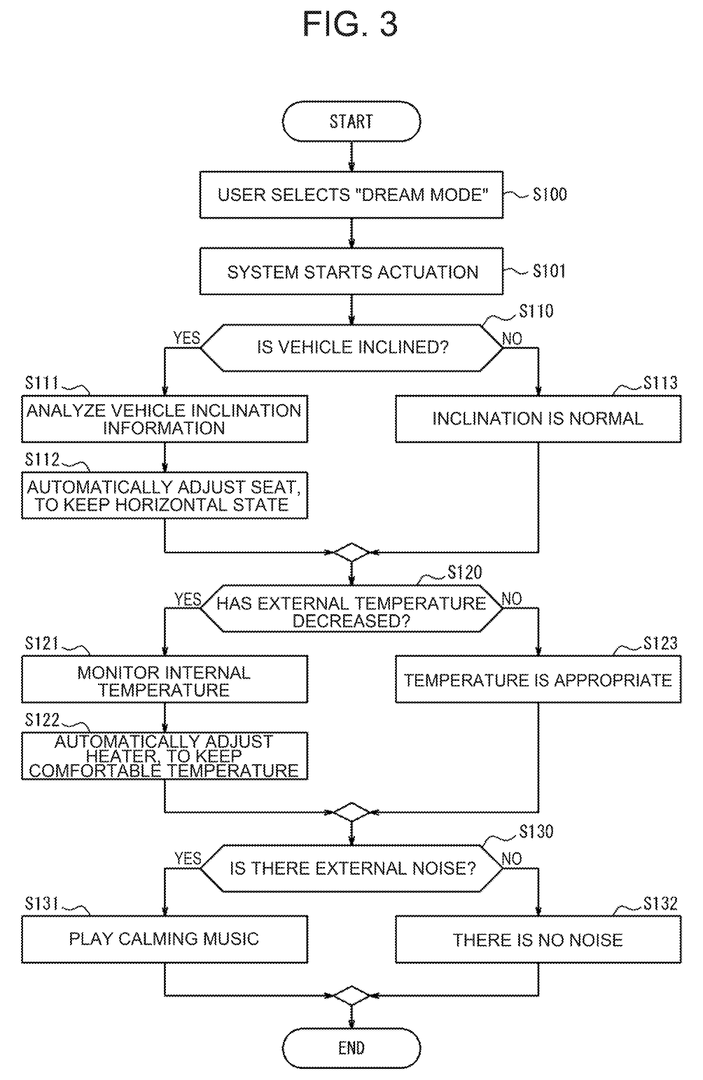

A first example of the operation of the vehicle control device 20 according to the embodiment will be described with reference to FIG. 3. The first example corresponds to an example of a vehicle control method according to the embodiment. That is, the control method according to the embodiment can include steps shown in FIG. 3.

In S100, the control unit 21 outputs a screen for setting the rest mode, from the output apparatus 31 through the communication unit 23. For example, the control unit 21 displays a screen allowing selection of one mode from two or more modes that are relevant to the internal environment of the vehicle 10 and that include the "Dream mode", on a display through the communication unit 23. Thereafter, the control unit 21 accepts a user's input for the setting of the rest mode to the input apparatus 32, through the communication unit 23. For example, the control unit 21 accepts a touch input for the selection of the "Dream mode" to a touch screen, through the communication unit 23. Alternatively, the control unit 21 may accept a voice input for the selection of the "Dream mode" to a microphone, through the communication unit 23.

The control unit 21 may accept the setting of the rest mode only when the vehicle 10 is at a standstill. For example, the communication unit 23 may receive information that is obtained using a vehicle velocity sensor of the vehicle 10 and that indicates the velocity of the vehicle 10. The control unit 21 may accept the touch input or voice input for the selection of the "Dream mode", only when the velocity of the vehicle 10 is zero.

Alternatively, the control unit 21 may accept the setting of the rest mode only when the autonomous driving level of the vehicle 10 is Level 4 or Level 5 in the level definition by SAE. For example, the communication unit 23 may receive information that is set in an autonomous driving ECU of the vehicle 10 and that indicates the autonomous driving level. "ECU" is an abbreviation for electronic control unit. The control unit 21 may accept the touch input or voice input for the selection of the "Dream mode", only when the autonomous driving level of the vehicle 10 is Level 4 or higher.

In S101, the control unit 21 starts the actuation of a system corresponding to the rest mode. After S101, the communication unit 23 receives the external situation information that is obtained using the in-vehicle sensor 40. The control unit 21 automatically adjusts the internal environment of the vehicle 10 based on the external situation information received by the communication unit 23, after the rest mode is set by the user 11 and before the rest mode is terminated.

The termination of the rest mode may be manually performed, or may be automatically performed. In the case of the manual termination, the control unit 21 terminates the rest mode, when the control unit 21 accepts a user's input for the termination of the rest mode to the input apparatus 32, through the communication unit 23. For example, the control unit 21 accepts a touch input for the selection of a different mode from the "Dream mode" to the touch screen, through the communication unit 23. Alternatively, the control unit 21 may accept a voice input for the selection of a different mode from the "Dream mode" to the microphone, through the communication unit 23. In the case of the automatic termination, the control unit 21 terminates the rest mode, when the control unit 21 detects that an automatic termination condition is satisfied. For example, the control unit 21 determines that the automatic termination condition is satisfied, at an alarm time set when the "Dream mode" is selected. Furthermore, the control unit 21 may output alarm sound from a speaker, through the communication unit 23.

In the first example shown in FIG. 3, the external situation information includes vehicle inclination information that is obtained using the inclination sensor 41. The vehicle inclination information is information that indicates the inclination of the vehicle 10 with respect to the gravity direction. The control unit 21 automatically adjusts one or both of the angles of a backrest and a footrest of the seat 12 in which the user 11 sits, to such an angle that one or both of the backrest and the footrest are orthogonal to the gravity direction, after the rest mode is set and before the rest mode is terminated. That is, the control unit 21 automatically adjusts one or both of the angles of the backrest and the footrest, depending on the inclination, after the rest mode is set and before the rest mode is terminated.

Specifically, in S110, the communication unit 23 receives the vehicle inclination information. The control unit 21 determines whether the vehicle 10 is inclined, based on the vehicle inclination information received in S110. In the case where it is determined that the vehicle 10 is inclined, for example, in the case where the vehicle 10 is stopped on a mountain road or a sloping road, the control unit 21, in S111, analyzes the vehicle inclination information received in S110. In S112, the control unit 21 automatically adjusts the seat 12, based on the analysis result obtained in S111, to keep a horizontal state. As a result, the occupant easily sleeps in a comfortable manner, regardless of the position of the vehicle 10. The horizontal state is not limited to a state where the whole of the seat 12 is flat, and may be, for example, a state where one or both of the backrest and the footrest has such an angle that one or both of the backrest and the footrest are orthogonal to the gravity direction but a seat surface does not have such an angle that the seat surface is orthogonal to the gravity direction. In the case where it is determined in S110 that the vehicle 10 is not inclined, the control unit 21 automatically adjusts the seat 12 such that the whole of the seat 12 is flat, in S113.

In the case where the setting of the rest mode is accepted only when the vehicle 10 is at a standstill, the control unit 21 only needs to acquire the vehicle inclination information through the communication unit 23, just once, when the rest mode is set. On the other hand, in the case where the setting of the rest mode is accepted only when the autonomous driving level of the vehicle 10 is Level 4 or Level 5, it is desirable for the control unit 21 to acquire the vehicle inclination information through the communication unit 23 in real time, after the rest mode is set and before the rest mode is terminated. Moreover, it is desirable for the control unit 21 to automatically alter one or both of the angles of the backrest and the footrest, depending on the change in the inclination.

In the first example shown in FIG. 3, the external situation information includes also external temperature information that is obtained using the temperature sensor 42. The external temperature information is information that indicates the external temperature of the vehicle 10. The control unit 21 automatically alters the setting of an in-vehicle heater or an in-vehicle air-conditioner depending on the change in the external temperature, after the rest mode is set and before the rest mode is terminated. In this example, the communication unit 23 further receives internal environment information that is obtained using the temperature sensor 51. The internal environment information is information that indicates the internal temperature of the vehicle 10. The control unit 21 acquires the internal environment information through the communication unit 23 in real time, and automatically alters the setting of the in-vehicle heater or the in-vehicle air-conditioner depending on the change in the internal temperature, when the control unit 21 detects that the external temperature is out of a desired range, after the rest mode is set and before the rest mode is terminated.

Specifically, in S120, the communication unit 23 receives the external temperature information. The control unit 21 determines whether the external temperature has decreased, based on the external temperature information received in S120. In the case where it is determined that the external temperature has decreased, the control unit 21, in S121, acquires the internal environment information through the communication unit 23 in real time, and monitors the internal temperature. In S122, the control unit 21 automatically adjusts the in-vehicle heater or the in-vehicle air-conditioner based on the monitoring result obtained in S121, to keep a comfortable temperature. As a result, the occupant easily sleeps in a comfortable manner, regardless of the temperature of the periphery of the vehicle 10. Furthermore, the control unit 21 may automatically alter the wind direction of the in-vehicle air-conditioner. In the case where it is determined in S120 that the external temperature has not decreased, the control unit 21 does not need to automatically adjust the in-vehicle heater or the in-vehicle air-conditioner, in S123.

It is desirable for the control unit 21 to acquire the external temperature information through the communication unit 23 in real time, after the rest mode is set and before the rest mode is terminated. Moreover, it is desirable for the control unit 21 to automatically alter the setting of the in-vehicle heater or the in-vehicle air-conditioner, depending on the change in the external temperature.

In this example, the external situation information may include external humidity information that is obtained using the humidity sensor 47, instead of or in addition to the external temperature information. The external humidity information is information that indicates the external humidity of the vehicle 10. The control unit 21 may automatically alter the setting of the in-vehicle air-conditioner or an in-vehicle humidifier depending on the change in the external humidity, after the rest mode is set and before the rest mode is terminated. For example, the control unit 21 may start a dehumidification operation of the in-vehicle air-conditioner, when the external humidity becomes a first threshold or higher. Alternatively, the control unit 21 may start an operation of the in-vehicle humidifier, when the external humidity becomes a second threshold or lower.

In the first example shown in FIG. 3, the external situation information includes external noise information that is obtained using the acoustic sensor 43. The external noise information is information that indicates the external noise of the vehicle 10. The control unit 21 automatically alters vehicle acoustics depending on the change in the external noise, after the rest mode is set and before the rest mode is terminated.

Specifically, in S130, the communication unit 23 receives the external noise information. The control unit 21 determines whether there is the external noise, based on the external noise information received in S130. In the case where it is determined that there is the external noise, the control unit 21 outputs calming music from a speaker through the communication unit 23, in S131. As a result, the occupant easily sleeps in a comfortable manner, regardless of the degree of the noise of the periphery of the vehicle 10. In the case where it is determined in S130 that there is no external noise, the control unit 21 does not need to output calming music from the speaker, in S132.

It is desirable for the control unit 21 to acquire the external noise information through the communication unit 23 in real time, after the rest mode is set and before the rest mode is terminated. Moreover, it is desirable for the control unit 21 to automatically alter the vehicle acoustics depending on the change in the external noise.

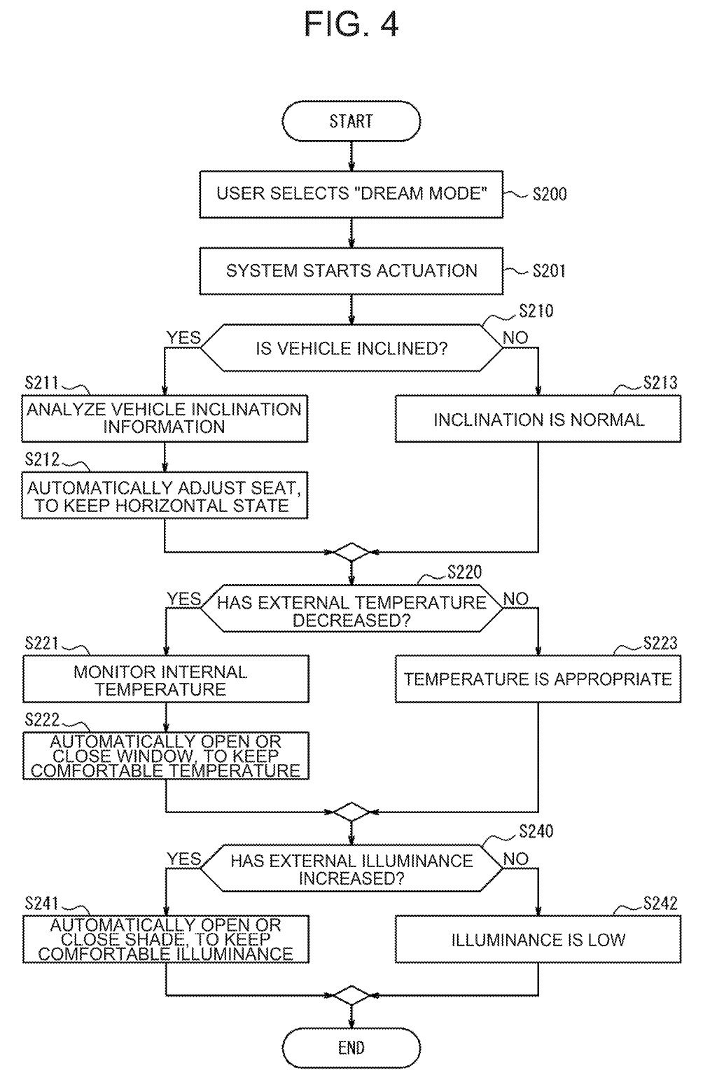

A second example of the operation of the vehicle control device 20 according to the embodiment will be described with reference to FIG. 4. The second example corresponds to a different example of the vehicle control method according to the embodiment. That is, the control method according to the embodiment can include steps shown in FIG. 4.

The steps in S200 and S201 are the same as the steps in S100 and S101 shown in FIG. 3, respectively, and therefore, descriptions thereof are omitted. After S201, the communication unit 23 receives the external situation information that is obtained using the in-vehicle sensor 40, similarly to the process after S101 in the first example shown in FIG. 3. The control unit 21 automatically adjusts the internal environment of the vehicle 10 based on the external situation information received by the communication unit 23, after the rest mode is set by the user 11 and before the rest mode is terminated.

In the second example shown in FIG. 4, the external situation information includes the vehicle inclination information that is obtained using the inclination sensor 41, similarly to the first example shown in FIG. 3. The control unit 21 automatically adjusts one or both of the angles of the backrest and the footrest, to such an angle that one or both of the backrest and the footrest are orthogonal to the gravity direction, after the rest mode is set and before the rest mode is terminated. The steps in S210 to S213 are the same as the steps in S110 to S113 shown in FIG. 3, respectively, and therefore, descriptions thereof are omitted.

In the second example shown in FIG. 4, the external situation information includes also the external temperature information that is obtained using the temperature sensor 42, similarly to the first example shown in FIG. 3. However, the control unit 21 automatically opens or closes the window 13 of the vehicle 10 depending on the change in the external temperature, after the rest mode is set and before the rest mode is terminated, unlike the first example shown in FIG. 3. In this example, the communication unit 23 further receives the internal environment information that is obtained using the temperature sensor 51, similarly to the first example shown in FIG. 3. However, the control unit 21 acquires the internal environment information through the communication unit 23 in real time and automatically opens or closes the window 13 depending on the change in the internal temperature, when the control unit 21 detects that the external temperature is out of a desired range, after the rest mode is set and before the rest mode is terminated, unlike the first example shown in FIG. 3.

Specifically, in S220, the communication unit 23 receives the external temperature information. The control unit 21 determines whether the external temperature has decreased, based on the external temperature information received in S220. In the case where it is determined that the external temperature has decreased, the control unit 21, in S221, acquires the internal environment information through the communication unit 23 in real time, and monitors the internal temperature. In S222, the control unit 21 automatically opens or closes the window 13 based on the monitoring result obtained in S221, to keep a comfortable temperature. As a result, the occupant easily sleeps in a comfortable manner, regardless of the temperature of the periphery of the vehicle 10. In the case where it is determined in S220 that the external temperature has not decreased, the control unit 21 does not need to automatically open or close the window 13, in S223.

It is desirable for the control unit 21 to acquire the external temperature information through the communication unit 23 in real time, after the rest mode is set and before the rest mode is terminated. Moreover, it is desirable for the control unit 21 to automatically open or close the window 13 depending on the change in the external temperature.

In this example, the external situation information may further include external odor information that is obtained using the odor sensor 45. The external odor information is information that indicates the external odor of the vehicle 10. It is desirable for the control unit 21 to close the window 13 regardless of the change in the external temperature, when the control unit 21 detects that the external odor is out of a desired range.

Alternatively, the external situation information may further include external air pollution degree information that is obtained using the air quality sensor 46. The external air pollution degree information is information that indicates the external air pollution degree of the vehicle 10. It is desirable for the control unit 21 to close the window 13 regardless of the change in the external temperature, when the control unit 21 detects that the external air pollution degree is out of a desired range.

In the second example shown in FIG. 4, the external situation information includes external illuminance information that is obtained using the illuminance sensor 44. The external illuminance information is information that indicates the external illuminance of the vehicle 10. The control unit 21 automatically opens or closes a shade attached to the window 13 of the vehicle 10 depending on the change in the external illuminance, after the rest mode is set and before the rest mode is terminated.

Specifically, in S240, the communication unit 23 receives the external illuminance information. The control unit 21 determines whether the external illuminance has increased, based on the external illuminance information received in S240. In the case where it is determined that the external illuminance has increased, the control unit 21 automatically opens or closes the shade, to keep a comfortable illuminance, in S241. As a result, the occupant easily sleeps in a comfortable manner, regardless of the brightness of the periphery of the vehicle 10. In the case where it is determined in S240 that the external illuminance has not increased, the control unit 21 does not need to automatically open or close the shade, in S242.

It is desirable for the control unit 21 to acquire the external illuminance information through the communication unit 23 in real time, after the rest mode is set and before the rest mode is terminated. Moreover, it is desirable for the control unit 21 to automatically open or close the shade depending on the change in the external illuminance.

The control unit 21 may automatically alter a vehicle illumination depending on the change in the external illuminance, after the rest mode is set and before the rest mode is terminated, instead of or in addition to the automatic opening or closing of the shade. For example, the control unit 21 may darken the illumination of meters or multimedia screens, as the external illuminance decreases. Alternatively, the control unit 21 may set the vehicle illumination to a blue illumination, when the external illuminance becomes a threshold or lower.

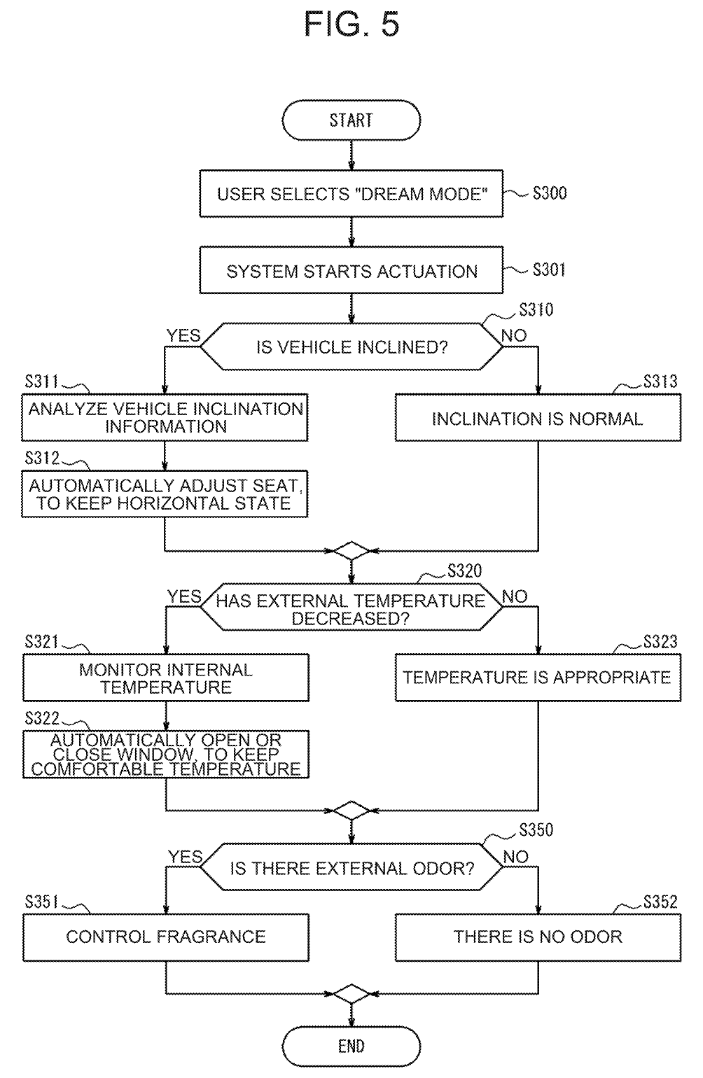

A third example of the operation of the vehicle control device 20 according to the embodiment will be described with reference to FIG. 5. The third example corresponds to a further different example of the vehicle control method according to the embodiment. That is, the control method according to the embodiment can include steps shown in FIG. 5.

The steps in S300 and S301 are the same as the steps in S100 and S101 shown in FIG. 3, respectively, and therefore, descriptions thereof are omitted. After S301, the communication unit 23 receives the external situation information that is obtained using the in-vehicle sensor 40, similarly to the process after S101 in the first example shown in FIG. 3. The control unit 21 automatically adjusts the internal environment of the vehicle 10 based on the external situation information received by the communication unit 23, after the rest mode is set by the user 11 and before the rest mode is terminated.

In the third example shown in FIG. 5, the external situation information includes the vehicle inclination information that is obtained using the inclination sensor 41, similarly to the first example shown in FIG. 3. The control unit 21 automatically adjusts one or both of the angles of the backrest and the footrest, to such an angle that one or both of the backrest and the footrest are orthogonal to the gravity direction, after the rest mode is set and before the rest mode is terminated. The steps in S310 to S313 are the same as the steps in S110 to S113 shown in FIG. 3, respectively, and therefore, descriptions thereof are omitted.

In the third example shown in FIG. 5, the external situation information includes also the external temperature information that is obtained using the temperature sensor 42, similarly to the second example shown in FIG. 4. The control unit 21 automatically opens or closes the window 13 depending on the change in the external temperature, after the rest mode is set and before the rest mode is terminated. In this example, the communication unit 23 further receives the internal environment information that is obtained using the temperature sensor 51, similarly to the second example shown in FIG. 4. The control unit 21 acquires the internal environment information through the communication unit 23 in real time and automatically opens or closes the window 13 depending on the change in the internal temperature, when the control unit 21 detects that the external temperature is out of a desired range, after the rest mode is set and before the rest mode is terminated. The steps in S320 to S323 are the same as the steps in S220 to S223 shown in FIG. 4, respectively, and therefore, descriptions thereof are omitted.

In the third example shown in FIG. 5, the external situation information includes the external odor information that is obtained using the odor sensor 45. The external odor information is information that indicates the external odor of the vehicle 10. The control unit 21 automatically alters the setting of an in-vehicle aroma machine depending on the change in the external odor, after the rest mode is set and before the rest mode is terminated.

Specifically, in S350, the communication unit 23 receives the external odor information. The control unit 21 determines whether there is the external odor, based on the external odor information received in S350. In the case where it is determined that there is the external odor, the control unit 21 controls fragrance using the in-vehicle aroma machine, in S351. As a result, the occupant easily sleeps in a comfortable manner, regardless of the degree of the odor of the periphery of the vehicle 10. In the case where it is determined in S350 that there is no external odor, the control unit 21 does not need to control the fragrance in S352.

It is desirable for the control unit 21 to acquire the external odor information through the communication unit 23 in real time, after the rest mode is set and before the rest mode is terminated. Moreover, it is desirable for the control unit 21 to automatically alter the setting of the in-vehicle aroma machine depending on the change in the external odor.

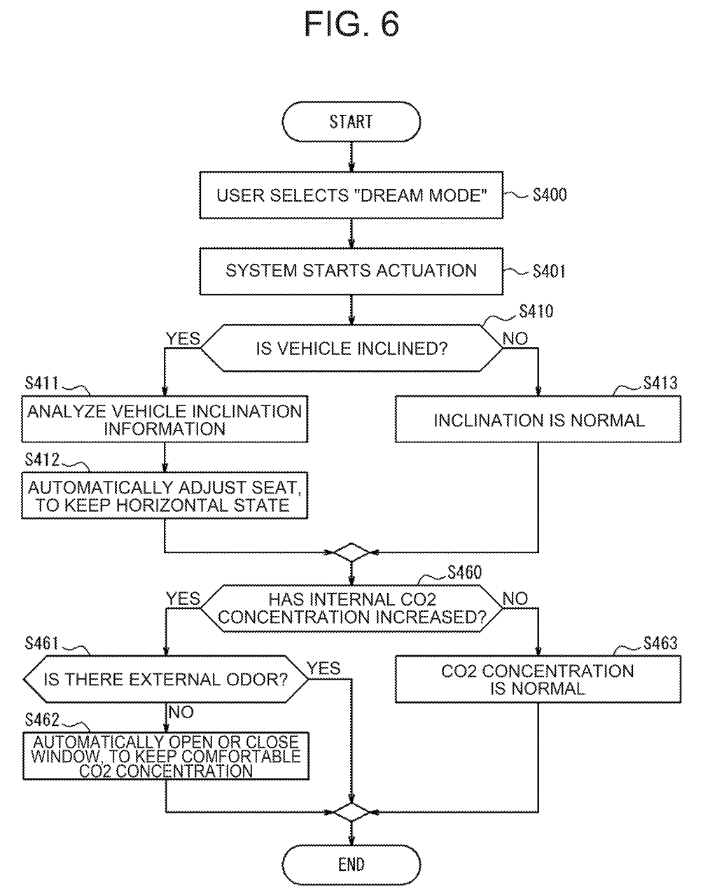

A fourth example of the operation of the vehicle control device 20 according to the embodiment will be described with reference to FIG. 6. The fourth example corresponds to a further different example of the vehicle control method according to the embodiment. That is, the control method according to the embodiment can include steps shown in FIG. 6.

The steps in S400 and S401 are the same as the steps in S100 and S101 shown in FIG. 3, respectively, and therefore, descriptions thereof are omitted. After S401, the communication unit 23 receives the external situation information that is obtained using the in-vehicle sensor 40, similarly to the process after S101 in the first example shown in FIG. 3. The control unit 21 automatically adjusts the internal environment of the vehicle 10 based on the external situation information received by the communication unit 23, after the rest mode is set by the user 11 and before the rest mode is terminated.

In the fourth example shown in FIG. 6, the external situation information includes the vehicle inclination information that is obtained using the inclination sensor 41, similarly to the first example shown in FIG. 3. The control unit 21 automatically adjusts one or both of the angles of the backrest and the footrest, to such an angle that one or both of the backrest and the footrest are orthogonal to the gravity direction, after the rest mode is set and before the rest mode is terminated. The steps in S410 to S413 are the same as the steps in S110 to S113 shown in FIG. 3, respectively, and therefore, descriptions thereof are omitted.

In the fourth example shown in FIG. 6, the communication unit 23 further receives internal environment information that is obtained using the carbon dioxide sensor 52. The internal environment information is information that indicates the internal carbon dioxide concentration of the vehicle 10. The control unit 21 acquires the internal environment information through the communication unit 23 in real time, after the rest mode is set and before the rest mode is terminated. Moreover, the control unit 21 automatically opens or closes the window 13 of the vehicle 10 depending on the change in the internal carbon dioxide concentration. In this example, the external situation information includes also the external odor information that is obtained using the odor sensor 45. The external odor information is information that indicates the external odor of the vehicle 10. The control unit 21 closes the window 13 regardless of the change in the internal carbon dioxide concentration, when the control unit 21 detects that the external odor is out of a desired range. Alternatively, the external situation information may include also the external air pollution degree information that is obtained using the air quality sensor 46. The external air pollution degree information is information that indicates the external air pollution degree of the vehicle 10. The control unit 21 may close the window 13 regardless of the change in the internal carbon dioxide concentration, when the control unit 21 detects that the external air pollution degree is out of a desired range.

Specifically, in S460, the control unit 21 acquires the internal environment information through the communication unit 23 in real time, and monitors the internal carbon dioxide concentration. The control unit 21 determines whether the internal carbon dioxide concentration has increased, based on the obtained monitoring result. In the case where it is determined that the internal carbon dioxide concentration has increased, the communication unit 23 receives the external odor information in S461. The control unit 21 determines whether there is the external odor, based on the received external odor information. In the case where it is determined that there is the external odor, the control unit 21 closes the window 13. In the case where it is determined that there is no external odor, the control unit 21, in S462, automatically opens or closes the window 13, based on the monitoring result obtained in S460, to keep a comfortable carbon dioxide concentration. As a result, the occupant easily sleeps in a comfortable manner. In the case where it is determined in S460 that the internal carbon dioxide concentration has not increased, the control unit 21 does not need to automatically open or close the window 13 in S463.

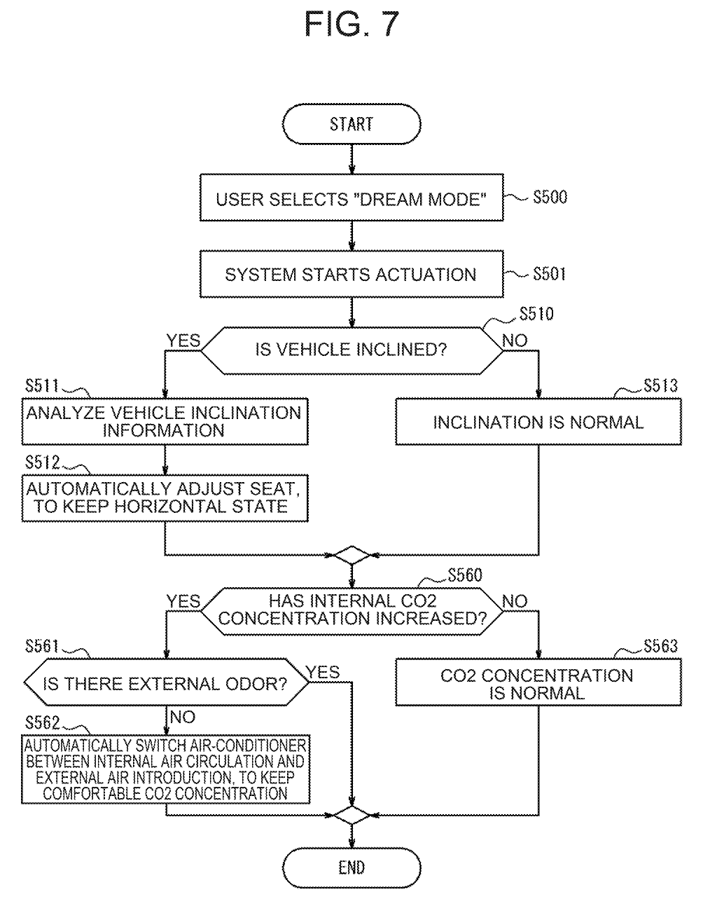

A fifth example of the operation of the vehicle control device 20 according to the embodiment will be described with reference to FIG. 7. The fifth example corresponds to a further different example of the vehicle control method according to the embodiment. That is, the control method according to the embodiment can include steps shown in FIG. 7.

The steps in S500 and S501 are the same as the steps in S100 and S101 shown in FIG. 3, respectively, and therefore, descriptions thereof are omitted. After S501, the communication unit 23 receives the external situation information that is obtained using the in-vehicle sensor 40, similarly to the process after S101 in the first example shown in FIG. 3. The control unit 21 automatically adjusts the internal environment of the vehicle 10 based on the external situation information received by the communication unit 23, after the rest mode is set by the user 11 and before the rest mode is terminated.

In the fifth example shown in FIG. 7, the external situation information includes the vehicle inclination information that is obtained using the inclination sensor 41, similarly to the first example shown in FIG. 3. The control unit 21 automatically adjusts one or both of the angles of the backrest and the footrest, to such an angle that one or both of the backrest and the footrest are orthogonal to the gravity direction, after the rest mode is set and before the rest mode is terminated. The steps in S510 to S513 are the same as the steps in S110 to S113 shown in FIG. 3, respectively, and therefore, descriptions thereof are omitted.

In the fifth example shown in FIG. 7, the communication unit 23 further receives the internal environment information that is obtained using the carbon dioxide sensor 52, similarly to the fourth example shown in FIG. 6. The control unit 21 acquires the internal environment information through the communication unit 23 in real time, after the rest mode is set and before the rest mode is terminated. Moreover, the control unit 21 automatically switches the in-vehicle air-conditioner between internal air circulation and external air introduction, depending on the change in the internal carbon dioxide concentration. In this example, the external situation information includes also the external odor information that is obtained using the odor sensor 45, similarly to the fourth example shown in FIG. 6. The control unit 21 sets the in-vehicle air-conditioner to the internal air circulation regardless of the change in the internal carbon dioxide concentration, when the control unit 21 detects that the external odor is out of a desired range. Alternatively, the external situation information may include also the external air pollution degree information that is obtained using the air quality sensor 46. The control unit 21 may set the in-vehicle air-conditioner to the internal air circulation regardless of the change in the internal carbon dioxide concentration, when the control unit 21 detects that the external air pollution degree is out of a desired range.

Specifically, in S560, the control unit 21 acquires the internal environment information through the communication unit 23 in real time, and monitors the internal carbon dioxide concentration. The control unit 21 determines whether the internal carbon dioxide concentration has increased, based on the obtained monitoring result. In the case where it is determined that the internal carbon dioxide concentration has increased, the communication unit 23 receives the external odor information in S561. The control unit 21 determines whether there is the external odor, based on the received external odor information. In the case where it is determined that there is the external odor, the control unit 21 sets the in-vehicle air-conditioner to the internal air circulation. In the case where it is determined that there is no external odor, the control unit 21, in S562, automatically switches the in-vehicle air-conditioner between the internal air circulation and the external air introduction, based on the monitoring result obtained in S560, to keep a comfortable carbon dioxide concentration. As a result, the occupant easily sleeps in a comfortable manner. In the case where it is determined in S560 that the internal carbon dioxide concentration has not increased, the control unit 21 does not need to automatically switch the in-vehicle air-conditioner between the internal air circulation and the external air introduction in S563.

Arbitrary step groups included in the five examples shown in FIG. 3 to FIG. 7 may be combined. Alternatively, an arbitrary step group may be excluded in one of the five examples shown in FIG. 3 to FIG. 7. For example, after the steps of S100 and S101 shown in FIG. 3, one or more step groups of a step group constituted by S110 to S113 shown in FIG. 3, a step group constituted by S120 to S123 shown in FIG. 3, a step group constituted by S130 to S132 shown in FIG. 3, a step group constituted by S240 to S242 shown in FIG. 4, a step group constituted by S350 to S352 shown in FIG. 5, and a step group constituted by S460 to S463 shown in FIG. 6 may be executed in an arbitrary order. A step group constituted by S220 to S223 shown in FIG. 4 may be executed instead of the step group constituted by S120 to S123 shown in FIG. 3. A step group constituted by S560 to S563 shown in FIG. 7 may be executed instead of the step group constituted by S460 to S463 shown in FIG. 6.

In each of S110, S120, and S130 shown in FIG. 3, S210, S220, and S240 shown in FIG. 4, S310, S320, and S350 shown in FIG. 5, S410 and S460 shown in FIG. 6, and S510 and S560 shown in FIG. 7, the determination of YES or NO may be made based on a fixed threshold, or the determination of YES or NO may be made based on a threshold that varies due to some kind of parameter.

In one of the five examples shown in FIG. 3 to FIG. 7, the control unit 21 may adjust the internal environment of the vehicle 10 in a fully automatic manner, without the intervention or confirmation by the user 11, after the rest mode is set and before the rest mode is terminated. That is, the rest mode may be operated as an unsolicited mode. Alternatively, the control unit 21 may display a message indicating that the user 11 is resting, as exemplified by a message "Do not disturb", on an external display of the vehicle 10, after the rest mode is set and before the rest mode is terminated.

In the embodiment, it is possible to adaptively adjust the sleep environment of the occupant, in response to the position of the vehicle 10 or the change in the external environment such as a climate condition or an acoustic situation. For example, it is possible to remove factors that constrain the quality of the sleep of a driver that performs a long-distance driving or a driving trip.

The present disclosure is not limited to the embodiment described above. For example, two or more blocks shown in the block diagram may be integrated or one block shown in the block diagram may be divided. Instead of executing two or more steps shown in the flowcharts in chronological order in accordance with the description, the two or more steps may be executed in parallel or in a different order, in accordance with processing capacities of devices that execute the steps, or as needed. Other than the above, alterations are possible without departing from the spirit of the present disclosure.

Some embodiments of the present disclosure will be exemplified below. However, note that embodiments of the present disclosure are not limited to these.

### Supplement 1

A vehicle control device comprising:

a communication unit configured to receive external situation information that is obtained using one or more in-vehicle sensors and that indicates an external situation of a vehicle; and

a control unit configured to automatically adjust an internal environment of the vehicle based on the external situation information received by the communication unit, after a rest mode is set by a user that rides in the vehicle and before the rest mode is terminated, the rest mode being a mode relevant to the internal environment.

### Supplement 2

The vehicle control device according to supplement 1, wherein the control unit is configured to accept the setting of the rest mode only when the vehicle is at a standstill.

### Supplement 3

The vehicle control device according to supplement 1 or 2, wherein the control unit is configured to acquire the external situation information through the communication unit in real time and automatically alter the internal environment depending on change in the external situation, after the rest mode is set and before the rest mode is terminated.

### Supplement 4

The vehicle control device according to any one of supplements 1 to 3, wherein:

the one or more in-vehicle sensors include an inclination sensor;

the external situation information includes information that is obtained using the inclination sensor and that indicates an inclination of the vehicle with respect to a gravity direction; and

the control unit is configured to automatically adjust one or both of angles of a backrest and a footrest of a seat in which the user sits, depending on the inclination, after the rest mode is set and before the rest mode is terminated.

### Supplement 5

The vehicle control device according to supplement 4, wherein the control unit is configured to automatically adjust one or both of the angles of the backrest and the footrest, to such an angle that one or both of the backrest and the footrest are orthogonal to the gravity direction, after the rest mode is set and before the rest mode is terminated.

### Supplement 6

The vehicle control device according to any one of supplements 1 to 5, wherein:

the one or more in-vehicle sensors include a temperature sensor;

the external situation information includes information that is obtained using the temperature sensor and that indicates an external temperature of the vehicle; and

the control unit is configured to automatically alter setting of an in-vehicle heater or an in-vehicle air-conditioner depending on change in the external temperature, after the rest mode is set and before the rest mode is terminated.

### Supplement 7

The vehicle control device according to supplement 6, wherein:

the communication unit is configured to further receive internal environment information that is obtained using a separate temperature sensor and that indicates an internal temperature of the vehicle, the separate temperature sensor being an in-vehicle sensor that is separate from the one or more in-vehicle sensors; and

the control unit is configured to acquire the internal environment information through the communication unit in real time and automatically alter the setting of the in-vehicle heater or the in-vehicle air-conditioner depending on change in the internal temperature, when the control unit detects that the external temperature is out of a desired range, after the rest mode is set and before the rest mode is terminated.

### Supplement 8

The vehicle control device according to any one of supplements 1 to 7, wherein:

the one or more in-vehicle sensors include a temperature sensor;

the external situation information includes information that is obtained using the temperature sensor and that indicates an external temperature of the vehicle; and

the control unit is configured to automatically open or close a window of the vehicle depending on change in the external temperature, after the rest mode is set and before the rest mode is terminated.

### Supplement 9

The vehicle control device according to supplement 8, wherein:

the one or more in-vehicle sensors further include an odor sensor or an air quality sensor;

the external situation information further includes information that is obtained using the odor sensor and that indicates an external odor of the vehicle, or information that is obtained using the air quality sensor and that indicates an external air pollution degree of the vehicle; and

the control unit is configured to close the window regardless of the change in the external temperature, when the control unit detects that the external odor or the external air pollution degree is out of a desired range.

### Supplement 10

The vehicle control device according to any one of supplements 1 to 9, wherein:

the one or more in-vehicle sensors include a humidity sensor;

the external situation information includes information that is obtained using the humidity sensor and that indicates an external humidity of the vehicle; and

the control unit is configured to automatically alter setting of an in-vehicle air-conditioner or an in-vehicle humidifier depending on change in the external humidity, after the rest mode is set and before the rest mode is terminated.

### Supplement 11

The vehicle control device according to any one of supplements 1 to 10, wherein:

the communication unit is configured to further receive internal environment information that is obtained using a carbon dioxide sensor and that indicates an internal carbon dioxide concentration of the vehicle, the carbon dioxide sensor being an in-vehicle sensor that is separate from the one or more in-vehicle sensors; and

the control unit is configured to acquire the internal environment information through the communication unit in real time and automatically open or close a window of the vehicle depending on change in the internal carbon dioxide concentration, after the rest mode is set and before the rest mode is terminated.

### Supplement 12

The vehicle control device according to supplement 11, wherein:

the one or more in-vehicle sensors include an odor sensor or an air quality sensor;

the external situation information includes information that is obtained using the odor sensor and that indicates an external odor of the vehicle, or information that is obtained using the air quality sensor and that indicates an external air pollution degree of the vehicle; and

the control unit is configured to close the window regardless of the change in the internal carbon dioxide concentration, when the control unit detects that the external odor or the external air pollution degree is out of a desired range.

### Supplement 13

The vehicle control device according to any one of supplements 1 to 12, wherein:

the communication unit is configured to further receive internal environment information that is obtained using a carbon dioxide sensor and that indicates an internal carbon dioxide concentration of the vehicle, the carbon dioxide sensor being an in-vehicle sensor that is separate from the one or more in-vehicle sensors; and

the control unit is configured to acquire the internal environment information through the communication unit in real time and automatically switch an in-vehicle air-conditioner between internal air circulation and external air introduction depending on change in the internal carbon dioxide concentration, after the rest mode is set and before the rest mode is terminated.

### Supplement 14

The vehicle control device according to supplement 13, wherein:

the one or more in-vehicle sensors include an odor sensor or an air quality sensor;

the external situation information includes information that is obtained using the odor sensor and that indicates an external odor of the vehicle, or information that is obtained using the air quality sensor and that indicates an external air pollution degree of the vehicle; and

the control unit is configured to set the in-vehicle air-conditioner to the internal air circulation regardless of the change in the internal carbon dioxide concentration, when the control unit detects that the external odor or the external air pollution degree is out of a desired range.

### Supplement 15

The vehicle control device according to any one of supplements 1 to 14, wherein:

the one or more in-vehicle sensors include an acoustic sensor;

the external situation information includes information that is obtained using the acoustic sensor and that indicates an external noise of the vehicle; and

the control unit is configured to automatically alter vehicle acoustics depending on change in the external noise, after the rest mode is set and before the rest mode is terminated.

### Supplement 16

The vehicle control device according to any one of supplements 1 to 15, wherein:

the one or more in-vehicle sensors include an illuminance sensor;

the external situation information includes information that is obtained using the illuminance sensor and that indicates an external illuminance of the vehicle; and

the control unit is configured to automatically open or close a shade attached to a window of the vehicle depending on change in the external illuminance, after the rest mode is set and before the rest mode is terminated.

### Supplement 17

The vehicle control device according to any one of supplements 1 to 16, wherein:

the one or more in-vehicle sensors include an illuminance sensor;

the external situation information includes information that is obtained using the illuminance sensor and that indicates an external illuminance of the vehicle; and

the control unit is configured to automatically alter a vehicle illumination depending on change in the external illuminance, after the rest mode is set and before the rest mode is terminated.

### Supplement 18

The vehicle control device according to any one of supplements 1 to 17, wherein:

the one or more in-vehicle sensors include an odor sensor;

the external situation information includes information that is obtained using the odor sensor and that indicates an external odor of the vehicle; and

the control unit is configured to automatically alter setting of an in-vehicle aroma machine depending on change in the external odor, after the rest mode is set and before the rest mode is terminated.

### Supplement 19

A vehicle comprising:

the vehicle control device according to any one of supplements 1 to 18; and

the one or more in-vehicle sensors.

### Supplement 20

A vehicle control method comprising:

receiving external situation information that is obtained using one or more in-vehicle sensors and that indicates an external situation of a vehicle; and

automatically adjusting an internal environment of the vehicle based on the received external situation information, after a rest mode is set by a user that rides in the vehicle and before the rest mode is terminated, the rest mode being a mode relevant to the internal environment.

What is claimed is:

1. A vehicle control device comprising:
a communication unit configured to receive external situation information that is obtained using one or more in-vehicle sensors and that indicates an external situation of a vehicle; and
a control unit configured to automatically adjust an internal environment of the vehicle based on the external situation information received by the communication unit, after a rest mode is set by a user that rides in the vehicle and before the rest mode is terminated, the rest mode being a mode relevant to the internal environment.

2. The vehicle control device according to claim 1, wherein the control unit is configured to accept the setting of the rest mode only when the vehicle is at a standstill.

3. The vehicle control device according to claim 1, wherein the control unit is configured to acquire the external situation information through the communication unit in real time and automatically alter the internal environment depending on change in the external situation, after the rest mode is set and before the rest mode is terminated.

4. The vehicle control device according to claim 1, wherein:
the one or more in-vehicle sensors include an inclination sensor;
the external situation information includes information that is obtained using the inclination sensor and that indicates an inclination of the vehicle with respect to a gravity direction; and
the control unit is configured to automatically adjust one or both of angles of a backrest and a footrest of a seat in which the user sits, depending on the inclination, after the rest mode is set and before the rest mode is terminated.

5. The vehicle control device according to claim 4, wherein the control unit is configured to automatically adjust one or both of the angles of the backrest and the footrest, to such an angle that one or both of the backrest and the footrest are orthogonal to the gravity direction, after the rest mode is set and before the rest mode is terminated.

6. The vehicle control device according to claim 1, wherein:
the one or more in-vehicle sensors include a temperature sensor;
the external situation information includes information that is obtained using the temperature sensor and that indicates an external temperature of the vehicle; and
the control unit is configured to automatically alter setting of an in-vehicle heater or an in-vehicle air-conditioner depending on change in the external temperature, after the rest mode is set and before the rest mode is terminated.

7. The vehicle control device according to claim 6, wherein:
the communication unit is configured to further receive internal environment information that is obtained using a separate temperature sensor and that indicates an internal temperature of the vehicle, the separate temperature sensor being an in-vehicle sensor that is separate from the one or more in-vehicle sensors; and
the control unit is configured to acquire the internal environment information through the communication unit in real time and automatically alter the setting of the in-vehicle heater or the in-vehicle air-conditioner depending on change in the internal temperature, when the control unit detects that the external temperature is out of a desired range, after the rest mode is set and before the rest mode is terminated.

8. The vehicle control device according to claim 1, wherein:
the one or more in-vehicle sensors include a temperature sensor;
the external situation information includes information that is obtained using the temperature sensor and that indicates an external temperature of the vehicle; and
the control unit is configured to automatically open or close a window of the vehicle depending on change in the external temperature, after the rest mode is set and before the rest mode is terminated.

9. The vehicle control device according to claim 8, wherein:
the one or more in-vehicle sensors further include an odor sensor or an air quality sensor;
the external situation information further includes information that is obtained using the odor sensor and that indicates an external odor of the vehicle, or information that is obtained using the air quality sensor and that indicates an external air pollution degree of the vehicle; and
the control unit is configured to close the window regardless of the change in the external temperature, when the control unit detects that the external odor or the external air pollution degree is out of a desired range.

10. The vehicle control device according to claim 1, wherein:
the one or more in-vehicle sensors include a humidity sensor;
the external situation information includes information that is obtained using the humidity sensor and that indicates an external humidity of the vehicle; and
the control unit is configured to automatically alter setting of an in-vehicle air-conditioner or an in-vehicle humidifier depending on change in the external humidity, after the rest mode is set and before the rest mode is terminated.

11. The vehicle control device according to claim 1, wherein:
the communication unit is configured to further receive internal environment information that is obtained using a carbon dioxide sensor and that indicates an internal carbon dioxide concentration of the vehicle, the carbon dioxide sensor being an in-vehicle sensor that is separate from the one or more in-vehicle sensors; and
the control unit is configured to acquire the internal environment information through the communication unit in real time and automatically open or close a window of the vehicle depending on change in the internal carbon dioxide concentration, after the rest mode is set and before the rest mode is terminated.

12. The vehicle control device according to claim 11, wherein:
the one or more in-vehicle sensors include an odor sensor or an air quality sensor;
the external situation information includes information that is obtained using the odor sensor and that indicates an external odor of the vehicle, or information that is obtained using the air quality sensor and that indicates an external air pollution degree of the vehicle; and
the control unit is configured to close the window regardless of the change in the internal carbon dioxide concentration, when the control unit detects that the external odor or the external air pollution degree is out of a desired range.

13. The vehicle control device according to claim 1, wherein:
the communication unit is configured to further receive internal environment information that is obtained using a carbon dioxide sensor and that indicates an internal carbon dioxide concentration of the vehicle, the carbon dioxide sensor being an in-vehicle sensor that is separate from the one or more in-vehicle sensors; and
the control unit is configured to acquire the internal environment information through the communication unit in real time and automatically switch an in-vehicle air-conditioner between internal air circulation and external air introduction depending on change in the internal carbon dioxide concentration, after the rest mode is set and before the rest mode is terminated.

14. The vehicle control device according to claim 13, wherein:
the one or more in-vehicle sensors include an odor sensor or an air quality sensor;
the external situation information includes information that is obtained using the odor sensor and that indicates an external odor of the vehicle, or information that is obtained using the air quality sensor and that indicates an external air pollution degree of the vehicle; and
the control unit is configured to set the in-vehicle air-conditioner to the internal air circulation regardless of the change in the internal carbon dioxide concentration, when the control unit detects that the external odor or the external air pollution degree is out of a desired range.

15. The vehicle control device according to claim 1, wherein:
the one or more in-vehicle sensors include an acoustic sensor;
the external situation information includes information that is obtained using the acoustic sensor and that indicates an external noise of the vehicle; and
the control unit is configured to automatically alter vehicle acoustics depending on change in the external noise, after the rest mode is set and before the rest mode is terminated.

16. The vehicle control device according to claim 1, wherein:
the one or more in-vehicle sensors include an illuminance sensor;
the external situation information includes information that is obtained using the illuminance sensor and that indicates an external illuminance of the vehicle; and
the control unit is configured to automatically open or close a shade attached to a window of the vehicle depending on change in the external illuminance, after the rest mode is set and before the rest mode is terminated.

17. The vehicle control device according to claim 1, wherein:
the one or more in-vehicle sensors include an illuminance sensor;
the external situation information includes information that is obtained using the illuminance sensor and that indicates an external illuminance of the vehicle; and
the control unit is configured to automatically alter a vehicle illumination depending on change in the external illuminance, after the rest mode is set and before the rest mode is terminated.

18. The vehicle control device according to claim 1, wherein:
the one or more in-vehicle sensors include an odor sensor;
the external situation information includes information that is obtained using the odor sensor and that indicates an external odor of the vehicle; and
the control unit is configured to automatically alter setting of an in-vehicle aroma machine depending on change in the external odor, after the rest mode is set and before the rest mode is terminated.

19. A vehicle comprising:
the vehicle control device according to claim 1; and
the one or more in-vehicle sensors.

20. A vehicle control method comprising:
receiving external situation information that is obtained using one or more in-vehicle sensors and that indicates an external situation of a vehicle; and
automatically adjusting an internal environment of the vehicle based on the received external situation information, after a rest mode is set by a user that rides in the vehicle and before the rest mode is terminated, the rest mode being a mode relevant to the internal environment.
